(19) United States
(12) Patent Application Publication
(10) Pub. No.: US 2008/0238236 A1
(43) Pub. Date: Oct. 2, 2008

(54) SWITCHED RELUCTANCE MACHINE

(75) Inventor: Ayman Mohamed Fawzi El-Refaie, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/691,550

(22) Filed: Mar. 27, 2007

(51) Int. Cl. H02K 16/02; H02K 17/00; H02K 19/20

(52) U.S. Cl. 310/166; 310/168; 310/266; 310/114

(57) ABSTRACT

A switched reluctance machine is provided. The switched reluctance machine has a rotor including a rotor core, where the rotor core includes multiple laminated sheets, each of the laminated sheets including multiple ferromagnetic regions and multiple non-ferromagnetic regions formed of a single material. The ferromagnetic and the non-ferromagnetic regions are alternately arranged such that the ferromagnetic regions form multiple rotor teeth and the non-ferromagnetic regions define multiple non-ferromagnetic gaps between the rotor teeth.

### BACKGROUND

The invention relates generally to switched reluctance machines and more specifically to, a smooth operation of switched reluctance machines.

Electric machines such as alternating current (AC) machines are typically not inherently fault tolerant. One of the primary reasons is that windings of AC machines are closely coupled magnetically. Thus, a short circuit in one winding affects adjacent phases. In a permanent magnet AC machine, rotating magnets generate potentially dangerous high currents in a short circuit path. Hence, adjacent phases may be seriously affected.

On the other hand, an electric machine such as a switched reluctance machine has windings concentrated on projecting stator poles. As a result, phase windings of a switched reluctance machine are devoid of magnetic coupling so that high currents in a winding do not magnetically induce high currents in adjacent phase windings. In general, the switched reluctance machine has multiple poles on a stator and a rotor. There is a concentrated winding on each of the poles on the stator. However, there is no concentrated winding on the pole of the rotor. A pair of diametrically opposite pole windings on the stator are connected in series or parallel to form an independent phase winding of a multiphase switched reluctance machine. Motoring torque is produced by switching current in each phase winding in a predetermined sequence that is synchronized with angular position of the rotor such that a magnetic force of attraction results between the poles of the rotor and the stator that approach each other.

While the typical switched reluctance machine provides several advantages over conventional electric machines such as AC machines as discussed above, a significant amount of noise, vibration and windage losses occur at high operating speeds and high operating temperatures.

Hence, there is a need to design an improved switched reluctance machine that addresses the aforementioned issues.

### BRIEF DESCRIPTION

In accordance with one embodiment of the invention, a switched reluctance machine is provided. The switched reluctance machine has a rotor comprising a rotor core. The rotor core comprises a number of laminated sheets, each of the laminated sheets having multiple ferromagnetic regions and multiple non-ferromagnetic regions formed of a single material. The ferromagnetic and the non-ferromagnetic regions are alternately arranged such that the ferromagnetic regions form multiple rotor teeth and the non-ferromagnetic regions define multiple non-ferromagnetic gaps between the rotor teeth. The switched reluctance machine also includes a stator comprising a stator core, wherein the stator core includes multiple stator teeth disposed with an air gap concentric with the rotor.

In accordance with another embodiment of the invention, a switched reluctance machine is provided. The switched reluctance machine has a stator including an inner stator portion and an outer stator portion. The inner stator portion includes an inner surface and multiple inner stator teeth disposed on the inner surface, and the outer stator portion is disposed concentrically around the inner stator portion and includes an outer surface and multiple outer stator teeth disposed on the outer surface. The switched reluctance machine also includes a rotor comprising an inner rotor core and an outer rotor core. The stator is disposed concentrically between the inner and outer rotor cores about a central axis. The outer rotor core comprises multiple outer laminated sheets, each of the outer laminated sheets including multiple outer ferromagnetic regions and multiple outer non-ferromagnetic regions formed of a single material. The outer ferromagnetic and non-ferromagnetic regions are alternately arranged such that the outer ferromagnetic regions form multiple outer rotor teeth and the outer non-ferromagnetic regions define multiple outer non-ferromagnetic gaps between the outer rotor teeth. The inner rotor core comprises multiple inner laminated sheets including multiple inner ferromagnetic regions and multiple inner non-ferromagnetic regions formed of a single material. The inner ferromagnetic and non-ferromagnetic regions are alternately arranged such that the inner ferromagnetic regions form multiple inner rotor teeth and the inner non-ferromagnetic regions define multiple inner non-ferromagnetic gaps between the inner rotor teeth.

In accordance with another embodiment of the invention, a switched reluctance machine is provided. The switched reluctance machine has a rotor including a rotor core, wherein the rotor core comprises multiple laminated sheets including multiple ferromagnetic regions and multiple non-ferromagnetic regions formed of a single material. The ferromagnetic and the non-ferromagnetic regions are alternately arranged such that the ferromagnetic regions form multiple rotor teeth and the non-ferromagnetic regions define multiple non-ferromagnetic gaps between the rotor teeth. The switched reluctance machine also has a stator comprising a stator core, wherein the stator core comprises multiple stator teeth disposed with an air gap inside and concentric with the rotor.

In accordance with another embodiment of the invention, a switched reluctance machine is provided. The switched reluctance machine has a stator including an inner stator portion and an outer stator portion, wherein the inner stator portion comprises an outer surface and multiple inner stator teeth disposed on the outer surface, and wherein the outer stator portion comprises an inner surface and multiple outer stator teeth disposed on the inner surface. The switched reluctance machine also has a double sided rotor including an inner rotor side and an outer rotor side, wherein the double sided rotor is concentrically disposed between the inner stator portion and the outer stator portion about a central axis. The double sided rotor comprises at least one laminated sheet, the laminated sheet including multiple outer ferromagnetic regions and multiple outer non-ferromagnetic regions formed of a single material. The outer ferromagnetic and non-ferromagnetic regions are alternately arranged such that the outer ferromagnetic regions form multiple outer rotor teeth and the outer non-ferromagnetic regions define multiple outer non-ferromagnetic gaps between the outer rotor teeth. The at least one laminated sheet further includes multiple inner ferromagnetic regions and multiple inner non-ferromagnetic regions formed of a single material. The inner ferromagnetic and non-ferromagnetic regions are alternately arranged such that the inner ferromagnetic regions form multiple inner rotor teeth and the inner non-ferromagnetic regions define multiple inner non-ferromagnetic gaps between the inner rotor teeth.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a switched reluctance machine in accordance with embodiments of the invention;

FIG. 2 is a perspective view of laminated sheets used in the rotor in FIG. 1;

FIG. 3 is a cross-sectional view of a dual rotor switched reluctance machine in accordance with embodiments of the invention;

FIG. 4 is a cross-sectional view of an inside-out switched reluctance machine in accordance with embodiments of the invention;

FIG. 5 is a cross-sectional view of a double-sided rotor switched reluctance machine in accordance with embodiments of the invention; and

FIG. 6 shows a laminated sheet for the dual-sided rotor of FIG. 5.

### DETAILED DESCRIPTION

As discussed in detail below, embodiments of the invention include a switched reluctance machine with a smooth rotor. As used herein, the term ‘smooth rotor’ refers to a rotor that helps reduce undesirable properties such as, but not limited to, noise, vibration and windage losses.

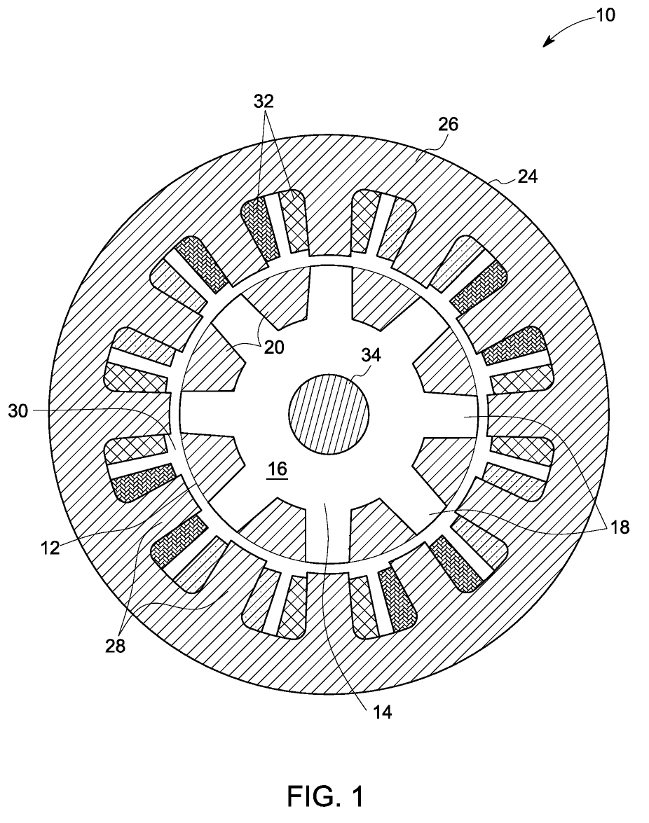

FIG. 1 is a diagrammatic illustration of a switched reluctance machine 10. The switched reluctance machine 10 includes a rotor 12 including a rotor core 14. The rotor 12 may also be referred to as a smooth rotor as defined above. The rotor core 14 includes multiple laminated sheets 16 disposed on top of each other. In a particular embodiment, the laminated sheets 16 have an integral structure. The laminated sheets 16 include multiple ferromagnetic regions 18 and non-ferromagnetic regions 20 that are alternately arranged and formed of a single material. In a particular embodiment, the single material is a dual phase ferromagnetic material. One example of the dual phase ferromagnetic material is disclosed in U.S. Pat. No. 6,255,005, to Tsutomu Inui et al, entitled “Composite magnetic member, method of producing ferromagnetic portion of same, and method of forming non-magnetic portion of same” and has a composition of Iron (Fe), 17.5% Chromium (Cr), 2% Nickel (Ni), 0.8% Aluminum (Al), 0.5% Carbon (C). In other examples, Cobalt is added to increase the magnetization. In other examples, chromium is replaced by weaker carbide forms, such as Mn, to increase the magnetization and reduce the thermal gradient required to create the dual-phase structure. In another embodiment, the laminated sheets 16 are subjected to a localized surface treatment to form the non-ferromagnetic regions 20. The ferromagnetic regions 18 form multiple rotor teeth and the non-ferromagnetic regions 20 define multiple non-ferromagnetic gaps between the ferromagnetic regions 18.

In a particular embodiment, the non-ferromagnetic regions 20 are subjected to a localized surface treatment by various means in order to induce an irreversible phase transformation to create the non-ferromagnetic areas. Non-limiting examples include local heat treatment by a laser beam, high temperature plasma and an electron beam or by mechanical strain. The non-ferromagnetic regions 20 prevent magnetic coupling so that high currents in a winding 32 will not magnetically induce high currents in an adjacent winding. Beneficially, the non-ferromagnetic regions 20 reduce windage losses, noise and vibrations in the switched reluctance machine 10.

The switched reluctance machine 10 also includes a stator 24 having a stator core 26. The stator core 26 includes multiple stator teeth 28 disposed with an air gap 30 concentric with the rotor 12. Windings 32 are wrapped around the stator teeth 28. Each pair of diametrically opposite stator teeth 28 is connected in series or parallel to form an independent phase winding of the switched reluctance machine 10. In an exemplary embodiment, the switched reluctance machine has a three phase winding. The rotor 12 is also coupled to a shaft 34 that enables rotation of the rotor 12.

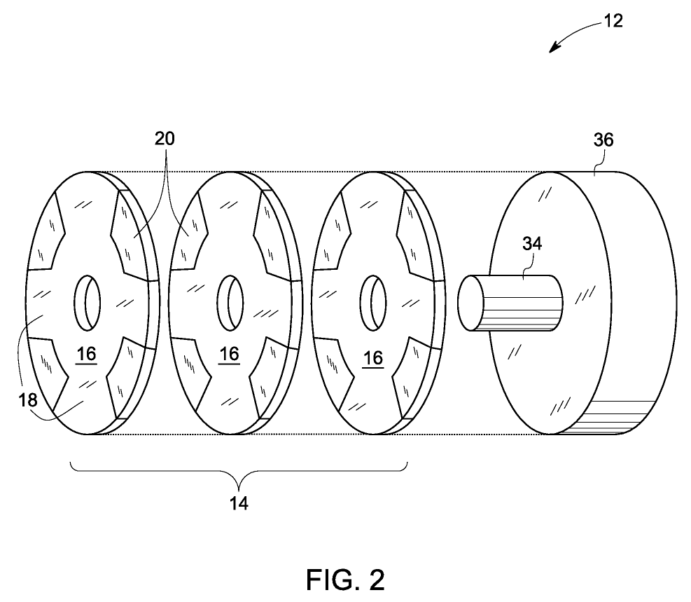

FIG. 2 is a perspective view of a stack of laminated sheets 16 forming a rotor 12. In the illustrated example, a holder 36 having a shaft 34 as referenced in FIG. 1 holds the laminated sheets 16. As discussed in FIG. 1, the rotor 12 includes a rotor core 14. The laminated sheets 16 are locally surface-treated to induce an irreversible phase transformation that creates ferromagnetic regions 18 and non-ferromagnetic regions 20 that are alternately arranged. In a particular embodiment, the laminated sheets 16 are surface treated by a localized heat treatment by a laser. In another embodiment, a localized surface treatment is provided by an electron beam radiation. For ease of illustration, the laminated sheets 16 shown in FIG. 2 include only four non-ferromagnetic regions 20 and four ferromagnetic regions 18. However, the invention is not limited to a specific number of rotor-poles.

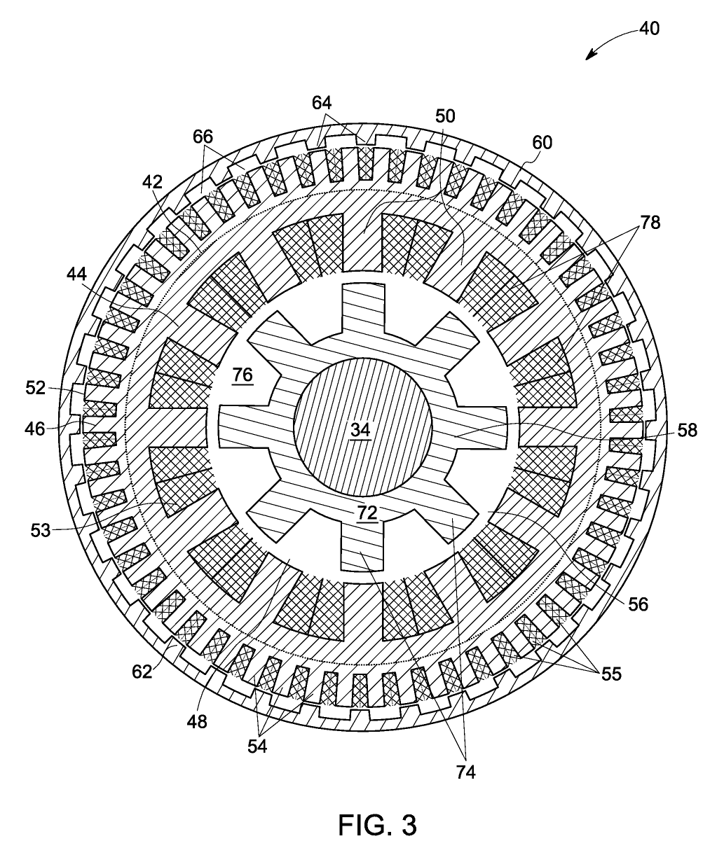

In accordance with another embodiment of the invention as shown in FIG. 3, a switched reluctance machine 40 is depicted. The switched reluctance machine 40 may also be termed a dual rotor switched reluctance machine. The switched reluctance machine 40 includes a stator 42 having an inner stator portion 44 and an outer stator portion 46. The inner stator portion 44 has an inner surface 48 and multiple inner stator teeth 50 disposed on the inner surface 48. The outer stator portion 46 is disposed concentrically around the inner stator portion 44 and includes an outer surface 52. The outer stator portion 46 also includes multiple outer stator teeth 54 disposed on the outer surface 52. Inner stator windings 53 and outer stator windings 55 are wrapped around the inner stator teeth 50 and the outer stator teeth 54 respectively.

The switched reluctance machine 40 also includes a rotor 56 having an inner rotor core 58 and an outer rotor core 60. The stator 42 is disposed concentrically between the inner rotor core 58 and the outer rotor core 60. The outer rotor core 60 includes multiple outer laminated sheets 62 having multiple outer ferromagnetic regions 64 and outer non-ferromagnetic regions 66 formed of a single material. In a particular embodiment, the single material is a dual phase ferromagnetic material. The outer ferromagnetic regions 64 and the outer non-ferromagnetic regions 66 are alternately arranged such that the outer ferromagnetic regions 64 form multiple outer rotor teeth and the outer non-ferromagnetic regions 66 define multiple outer non-ferromagnetic gaps between the outer rotor teeth.

Similarly, the inner rotor core 58 includes multiple inner laminated sheets 72 having multiple inner ferromagnetic regions 74 and inner non-ferromagnetic regions 76 formed of a single material. The inner ferromagnetic regions 74 and the inner non-ferromagnetic regions 76 are alternately arranged such that the inner ferromagnetic regions 74 form multiple inner rotor teeth and the outer non-ferromagnetic regions 76 define multiple outer non-ferromagnetic gaps between the outer non-ferromagnetic regions 76. In a particular embodiment, the outer laminated sheets 68 and the inner laminated sheets 72 are subjected to a localized surface treatment to form the outer non-ferromagnetic regions 66 and the inner non-ferromagnetic regions 76 respectively. In a particular embodiment, the non-ferromagnetic regions 66 and 76 are heat-treated by various means. Some non-limiting examples include heating by a laser beam, high temperature plasma and an electron beam.

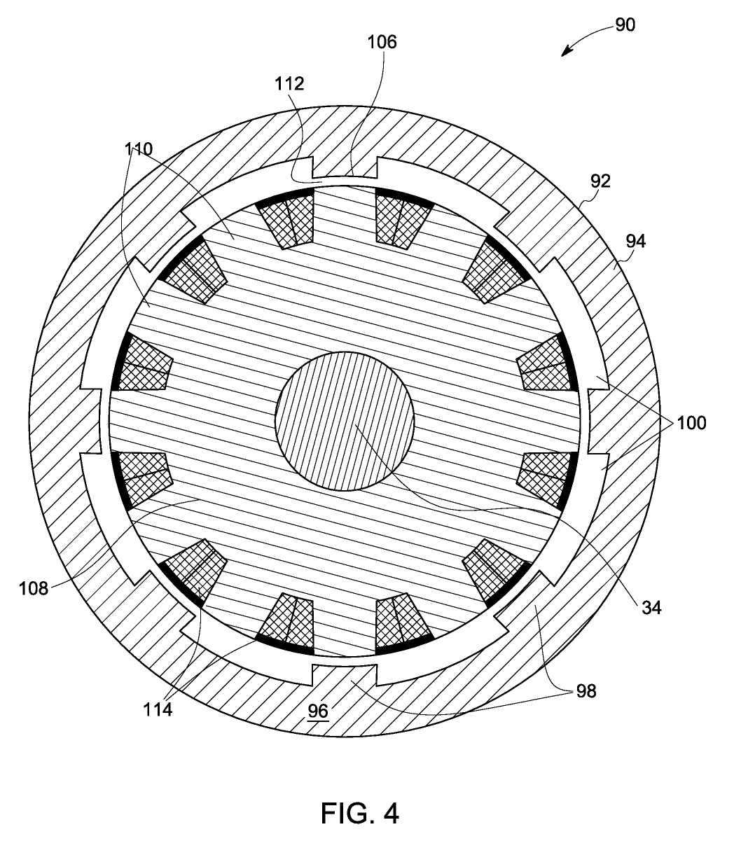

In accordance with yet another embodiment of the invention as shown in FIG. 4, a switched reluctance machine 90 is depicted. The switched reluctance machine 90 may also be referred to as an inside-out switched reluctance machine. The switched reluctance machine 90 includes a rotor 92 having a rotor core 94. The rotor core 94 includes multiple laminated sheets 96 having multiple ferromagnetic regions 98 and multiple non-ferromagnetic regions 100 formed of a single material. In a particular embodiment, the single material is a dual phase ferromagnetic material.

In a particular embodiment, the laminated sheets 96 are subjected to a localized surface treatment to form the non-ferromagnetic regions 100. In a particular embodiment, the non-ferromagnetic regions 100 are heat-treated by various means. Non-limiting examples include heating by a laser beam, high temperature plasma and an electron beam. The ferromagnetic regions 98 form multiple rotor teeth and the non-ferromagnetic regions 100 define multiple non-ferromagnetic gaps between the ferromagnetic regions 100. The switched reluctance machine 90 also includes a stator 106 having a stator core 108. The stator core 108 includes multiple stator teeth 110 disposed with an air gap 112 inside and concentric with the rotor 92. Windings 114 are wrapped around the stator teeth 110. Each pair of diametrically opposite stator teeth 110 is connected in series or parallel to form an independent phase winding of the switched reluctance machine 90. In an exemplary embodiment, the switched reluctance machine has a three phase winding.

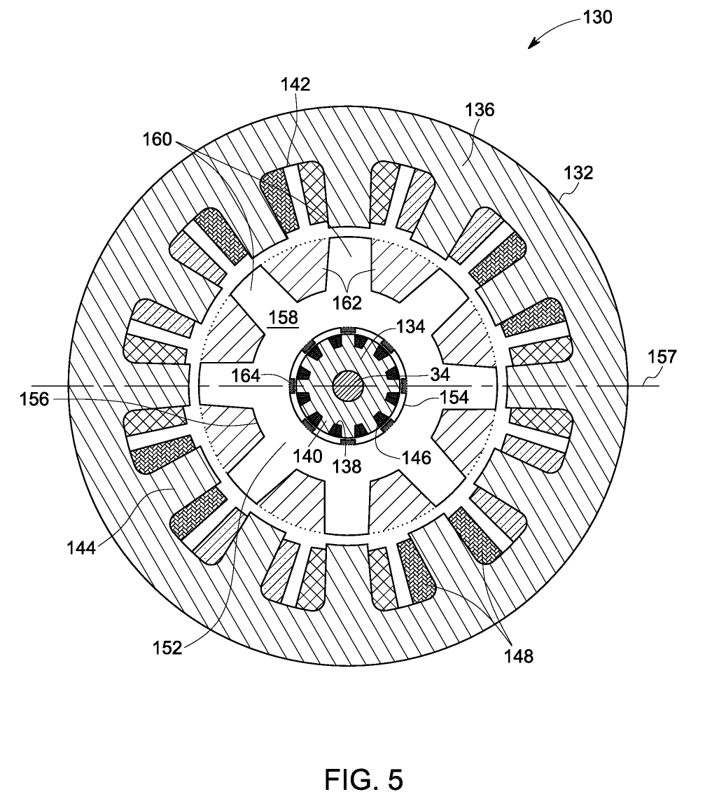

FIG. 5 is a cross-sectional view of another embodiment of a switched reluctance machine 130. The switched reluctance machine 130 may also be termed as a double-sided rotor switched reluctance machine. The switched reluctance machine 130 includes a stator 132 having an inner stator portion 134 and an outer stator portion 136. The inner stator portion 134 has an outer surface 138 and multiple inner stator teeth 140 disposed on the outer surface 138. The outer stator portion 136 includes an inner surface 142 and multiple outer stator teeth 144 disposed on the inner surface 142. Inner stator windings 146 and outer stator windings 148 are wrapped around the inner stator teeth 140 and the outer stator teeth 144 respectively.

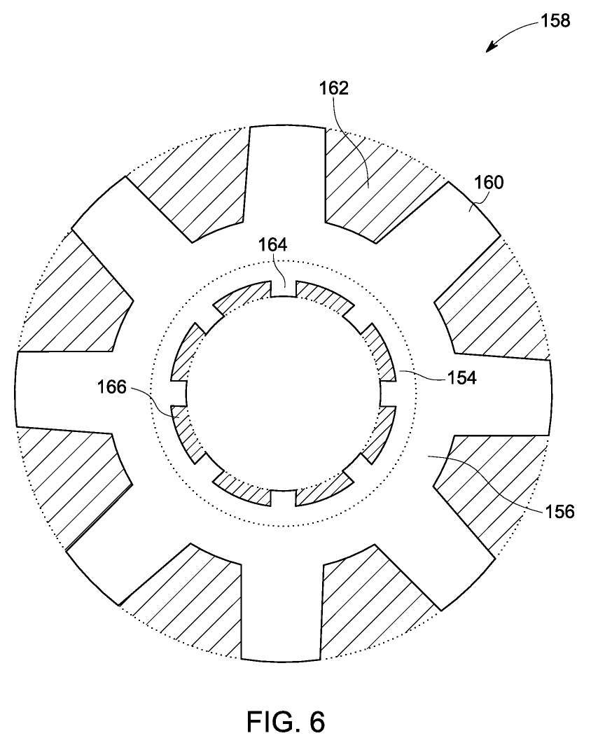

The switched reluctance machine 130 also includes a double sided rotor 152 having an inner rotor side 154 and an outer rotor side 156. The double sided rotor 152 is disposed concentrically between the inner stator portion 134 and the outer stator portion 136 about a central axis 157. For particular embodiments, the dual sided rotor 152 comprises multiple laminated sheets 158. An example laminated sheet 158 is illustrated in FIG. 6. As indicated in FIG. 6, for example, the at least one laminated sheet 158 defines multiple outer ferromagnetic regions 160 and outer non-ferromagnetic regions 162 formed of a single material. In a particular embodiment, the single material is a dual phase ferromagnetic material. The outer ferromagnetic regions 160 and the outer non-ferromagnetic regions 162 are alternately arranged such that the outer ferromagnetic regions 160 form multiple outer rotor teeth and the outer non-ferromagnetic regions 162 define multiple outer non-ferromagnetic gaps between the outer rotor teeth. The rotor 152 is also coupled to a shaft 34 that enables rotation of the rotor 152.

Similarly, the laminated sheet 158 defines multiple inner ferromagnetic regions 164 and inner non-ferromagnetic regions 166 formed of a single material, as shown for example in FIG. 6. The inner ferromagnetic regions 164 and the inner non-ferromagnetic regions 166 are alternately arranged such that the inner ferromagnetic regions 164 form multiple inner rotor teeth and the outer non-ferromagnetic regions 162 define multiple outer non-ferromagnetic gaps between the outer non-ferromagnetic regions 162. In a particular embodiment, each of the laminated sheet(s) 158 is subjected to a localized surface treatment to form the inner non-ferromagnetic regions 166 and the outer non-ferromagnetic regions 162 simultaneously. In another embodiment, the non-ferromagnetic regions 164 and 166 are heat-treated by various means. Some non-limiting examples include heating by a laser beam, high temperature plasma and an electron beam.

The various embodiments of a switched reluctance machine described above thus provide a way to provide a smooth rotor with minimal noise, vibrations, and windage losses even at high operating speeds and high operating temperatures. These techniques and systems also allow for highly efficient switched reluctance machines that use the rotor.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an example of a dual phase magnetic material described with respect to one embodiment can be adapted for use with an inside-out switched reluctance machine described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A switched reluctance machine comprising:
a rotor comprising a rotor core, wherein the rotor core comprises a plurality of laminated sheets, each of the laminated sheets comprising a plurality of ferromagnetic regions and a plurality of non-ferromagnetic regions formed of a single material, wherein the ferromagnetic and the non-ferromagnetic regions are alternately arranged such that the ferromagnetic regions form a plurality of rotor teeth and the non-ferromagnetic regions define a plurality of non-ferromagnetic gaps between the rotor teeth; and
a stator comprising a stator core, wherein the stator core comprises a plurality of stator teeth disposed with an air gap concentric with the rotor.

2. The switched reluctance machine of claim 1, wherein the laminated sheets have an integral structure.

3. The switched reluctance machine of claim 1, wherein the laminated sheets are subjected to a localized surface treatment to form the non-ferromagnetic regions.

4. A switched reluctance machine comprising:
a stator comprising an inner stator portion and an outer stator portion, wherein the inner stator portion comprises an inner surface and a plurality of inner stator teeth disposed on the inner surface, and wherein the outer stator portion is disposed concentrically around the inner stator portion and comprises an outer surface and a plurality of outer stator teeth disposed on the outer surface; and
a rotor comprising an inner rotor core and an outer rotor core, wherein the stator is disposed concentrically between the inner and outer rotor cores about a central axis,
wherein the outer rotor core comprises a plurality of outer laminated sheets, each of the outer laminated sheets comprising a plurality of outer ferromagnetic regions and a plurality of outer non-ferromagnetic regions formed of a single material, wherein the outer ferromagnetic and non-ferromagnetic regions are alternately arranged such that the outer ferromagnetic regions form a plurality of outer rotor teeth and the outer non-ferromagnetic regions define a plurality of outer non-ferromagnetic gaps between the outer rotor teeth, and
wherein the inner rotor core comprises a plurality of inner laminated sheets comprising a plurality of inner ferromagnetic regions and a plurality of inner non-ferromagnetic regions formed of a single material, wherein the inner ferromagnetic and non-ferromagnetic regions are alternately arranged such that the inner ferromagnetic regions form a plurality of inner rotor teeth and the inner non-ferromagnetic regions define a plurality of inner non-ferromagnetic gaps between the inner rotor teeth.

5. The switched reluctance machine of claim 4, wherein the laminated sheets have an integral structure.

6. The switched reluctance machine of claim 4, wherein the plurality of outer laminated sheets and the plurality of inner laminated sheets are subjected to a localized surface treatment to form the outer non-ferromagnetic regions and the inner non-ferromagnetic regions respectively.

7. A switched reluctance machine comprising:
a rotor comprising a rotor core, wherein the rotor core comprises a plurality of laminated sheets comprising a plurality of ferromagnetic regions and a plurality of non-ferromagnetic regions formed of a single material, wherein the ferromagnetic and the non-ferromagnetic regions are alternately arranged such that the ferromagnetic regions form a plurality of rotor teeth and the non-ferromagnetic regions define a plurality of non-ferromagnetic gaps between the rotor teeth; and
a stator comprising a stator core, wherein the stator core comprises a plurality of stator teeth disposed with an air gap inside and concentric with the rotor.

8. The switched reluctance machine of claim 7, wherein the laminated sheets have an integral structure.

9. The switched reluctance machine of claim 7, wherein the laminated sheets are subjected to a localized surface treatment to form the non-ferromagnetic regions.

10. A switched reluctance machine comprising:
a stator comprising an inner stator portion and an outer stator portion, wherein the inner stator portion comprises an outer surface and a plurality of inner stator teeth disposed on the outer surface, and wherein the outer stator portion comprises an inner surface and a plurality of outer stator teeth disposed on the inner surface; and
a double sided rotor comprising an inner rotor side and an outer rotor side, wherein the double sided rotor is concentrically disposed between the inner stator portion and the outer stator portion about a central axis,
wherein the double sided rotor comprises at least one laminated sheet, the laminated sheet comprising a plurality of outer ferromagnetic regions and a plurality of outer non-ferromagnetic regions formed of a single material, wherein the outer ferromagnetic and non-ferromagnetic regions are alternately arranged such that the outer ferromagnetic regions form a plurality of outer rotor teeth and the outer non-ferromagnetic regions define a plurality of outer non-ferromagnetic gaps between the outer rotor teeth, and
wherein the at least one laminated sheet further comprises a plurality of inner ferromagnetic regions and a plurality of inner non-ferromagnetic regions formed of a single material, wherein the inner ferromagnetic and non-ferromagnetic regions are alternately arranged such that the inner ferromagnetic regions form a plurality of inner rotor teeth and the inner non-ferromagnetic regions define a plurality of inner non-ferromagnetic gaps between the inner rotor teeth.

11. The switched reluctance machine of claim 10, wherein the laminated sheet has an integral structure.

12. The switched reluctance machine of claim 10, wherein the laminated sheet is subjected to a localized surface treatment to form the non-ferromagnetic regions simultaneously on the inner rotor side and the outer rotor side.
